(19) United States
(12) Patent Application Publication
(10) Pub. No.: US 2026/0009901 A1
(43) Pub. Date: Jan. 8, 2026

(54) LIDAR HAVING SPATIO-TEMPORAL FILTERING

(71) Applicant: Allegro MicroSystems, LLC, Manchester, NH (US)

(72) Inventor: Devin Wolfe, Aloha, OR (US)

(73) Assignee: Allegro MicroSystems, LLC, Manchester, NH (US)

(21) Appl. No.: 18/366,091

(22) Filed: Aug. 7, 2023

(51) Int. Cl. G01S 17/04; G01S 7/48; G01S 7/487; H04N 25/40; H04N 25/618

(52) U.S. Cl. CPC G01S 17/04; G01S 7/4808; G01S 7/4876; H04N 25/41; H04N 25/618

(57) ABSTRACT

Methods and apparatus for a lidar system having spatio-temporal filtering to reduce false alarms in image data. In embodiments, the probability of a lidar return being real and not a false alarm is calculated based on both the current and historical presence of other returns which are spatially adjacent to the return being calculated. The probability is used to filter false alarms through thresholding.

### BACKGROUND

As is known in the art, lidar is a neologism combining “light” with “radar” and broadly encompasses a range of photonics technologies used to assemble a 3D image. A lidar image is composed of many discrete measurements using a light source (laser) and a photodetector. Photodetectors convert light into measurable electric current, and the presence of current from the photodetector is taken to indicate the presence of light. A signal on the photodetector originating from transmitted laser light which has reflected off an object is called a return, a term originating from radar.

However, photodetectors are also a noisy current source on their own which may make it difficult to distinguish the return from a real object from an ignorable noise event. A noise event originating from the photodetector that exceeds the detection threshold and is captured during a measurement is referred to as a false alarm.

There are various known methods that attempt to distinguish between real returns and false alarms, such as measuring amplitude or pulse shape, or modulating the laser signal. However, even with these techniques, eliminating false alarms is a problem.

False alarms reduce the performance of lidar systems by cluttering the image. They can obscure real objects in the image, distort the outlines or perceived shape of objects, or cause the processing system to mistakenly conclude that there is an object where none exists. This can have real world safety implications, for example an autonomous vehicle making driving decisions based on incorrect or poor-quality information.

Conversely, lowering the false alarm rate (FAR) can improve key performance metrics of the lidar system. For example, there is a negative correlation between detection threshold/maximum range and the FAR. If false alarms can be eliminated, the detection threshold can be lowered, increasing the achievable maximum range.

Time-of-flight laser ranging systems generally work by emitting a laser pulse and recording the time it takes for the laser pulse to travel to a target, reflect, and return to a photoreceiver. The laser ranging instrument records the time of the outgoing pulse and records the time that a laser pulse returns. The difference between these two times is the time of flight to and from the target. Using the speed of light, the round-trip time of the pulses is used to calculate the distance to the target.

### SUMMARY

Example embodiments of the disclosure provide methods and apparatus for spatio-temporal filtering to reduce false detections in image data. In embodiments, image data can be searched, such as by using a bounded window, and probabilities for active measurements can be adjusted. In embodiments, non-zero measurements are thresholded and measurements above the threshold are stored.

In one aspect, a method comprises: (a) receiving a first set of lidar data comprising multiple measurements having non-zero range returns; (b) processing each measurement in the first set of lidar data to identify other spatially adjacent measurements with non-zero returns using a defined search area around the measurement currently being processed; (c) for each spatially adjacent measurement with a non-zero return in the search area surrounding the measurement currently being processed, increasing a metric of a probability for the measurement currently being processed of a real return at a range of the adjacent non-zero return; (d) persistently storing the metrics of probability in memory across iterations of processing each measurement in the first set of lidar data; (e) decreasing the probability metric for ranges of measurements for which spatially adjacent returns were not found within the search area; (f) receiving subsequent sets of lidar data at a time after receiving the first set of lidar data; (g) processing the subsequent sets of lidar data in accordance with steps (a)-(e) to identify spatially adjacent returns and update the persistent probability metrics for each measurement at each range; (h) for each of the first and subsequent sets of lidar data, after updating the probability for each measurement having a non-zero return, comparing the probability metric for the measurement at the range of the return to a threshold to identify real returns; (i) removing returns whose probability does not meet the threshold and/or or replacing them with another value; and (j) displaying an image based on the identified real returns.

A method can further include one or more of the following features: the search area and/or spatial adjacency are defined in terms of elevation and azimuth of lidar measurements, defining the search area and/or spatial adjacency using calculated cartesian coordinates of a return using elevation, azimuth and range of the measurement that generated the return, the probability of a measurement with a non-zero return at the range of that return is compared to a probability threshold, and further including combining the probabilities of range bins adjacent to the range bin corresponding to the range of the return prior to comparison to the threshold, maintaining a table of range bins for each measurement with a unique elevation and azimuth, wherein each the range bins stores a probability metric for a sub-set of possible ranges, pixels comprise photodetectors that generate random noise in the measurements, and/or false alarms are generated by the random noise.

In another aspect, a system comprises: one or more processors and one or more memories in a lidar system configured to: (a) receive a first set of lidar data comprising multiple measurements having non-zero range returns; (b) process each measurement in the first set of lidar data to identify other spatially adjacent measurements with non-zero returns using a defined search area around the measurement currently being processed; (c) for each spatially adjacent measurement with a non-zero return in the search area surrounding the measurement currently being processed, increase a metric of a probability for the measurement currently being processed of a real return at a range of the adjacent non-zero return; (d) persistently store the metrics of probability in memory across iterations of processing each measurement in the first set of lidar data; (e) decrease the probability metric for ranges of measurements for which spatially adjacent returns were not found within the search area; (f) receive subsequent sets of lidar data at a time after receiving the first set of lidar data; (g) process the subsequent sets of lidar data in accordance with steps (a)-(e) to identify spatially adjacent returns and update the persistent probability metrics for each measurement at each range; (h) for each of the first and subsequent sets of lidar data, after updating the probability for each measurement having a non-zero return, compare the probability metric for the measurement at the range of the return to a threshold to identify real returns; (i) remove returns whose probability does not meet the threshold and/or or replacing them with another value; and (j) display an image based on the identified real returns.

A system can further include one or more of the following features: the search area and/or spatial adjacency are defined in terms of elevation and azimuth of lidar measurements, defining the search area and/or spatial adjacency using calculated cartesian coordinates of a return using elevation, azimuth and range of the measurement that generated the return, the probability of a measurement with a non-zero return at the range of that return is compared to a probability threshold, and further including combining the probabilities of range bins adjacent to the range bin corresponding to the range of the return prior to comparison to the threshold, maintaining a table of range bins for each measurement with a unique elevation and azimuth, wherein each the range bins stores a probability metric for a sub-set of possible ranges, pixels comprise photodetectors that generate random noise in the measurements, and/or false alarms are generated by the random noise.

### BRIEF DESCRIPTION OF THE DRAWINGS

The foregoing features of this disclosure, as well as the disclosure itself, may be more fully understood from the following description of the drawings in which:

FIG. 1 is a block diagram showing components of an example embodiment of a lidar system having spatio-temporal filtering;

FIG. 2 is a diagram of an exemplary scanning lidar system having spatio-temporal filtering;

FIG. 3 is a block diagram of an example time-of-flight (TOF) lidar system having spatio-temporal filtering;

FIGS. 4A-4D shows an object at five meters moving across the scene over time;

FIGS. 5A-5D shows example image data for an object moving over time and changing probabilities;

FIG. 6 shows example image data with measurement values based on signal return;

FIG. 6A shows example image data with example probabilities for a group of range bins;

FIG. 6B shows example image data with a search window;

FIGS. 6C, 6D, and 6E show a search window moving across the image data over time;

FIG. 6F shows example image data with a search window and probability processing;

FIG. 6G shows an example data image and example threshold processing;

FIG. 6H shows a schematic representation of scan of measurements that can be indexed;

FIG. 7 is a flow diagram showing example steps to search and process image data;

FIG. 8 is a flow diagram showing example steps to threshold image data; and

FIG. 9 is a schematic representation of an example computer that can perform at least a portion of the processing described herein.

### DETAILED DESCRIPTION

Prior to describing example embodiments of the disclosure some information is provided. Laser ranging systems can include laser radar (ladar), light-detection and ranging (lidar), and rangefinding systems, which are generic terms for the same class of instrument that uses light to measure the distance to objects in a scene. This concept is similar to radar, except optical signals are used instead of radio waves. Similar to radar, a laser ranging and imaging system emits a pulse toward a particular location and measures the return echoes to extract the range.

Laser ranging systems generally work by emitting a laser pulse and recording the time it takes for the laser pulse to travel to a target, reflect, and return to a photoreceiver. The laser ranging instrument records the time of the outgoing pulse—either from a trigger or from calculations that use measurements of the scatter from the outgoing laser light—and then records the time that a laser pulse returns. The difference between these two times is the time of flight to and from the target. Using the speed of light, the round-trip time of the pulses is used to calculate the distance to the target.

Lidar systems may use a single element, scanning the beam across the target area to measure distance at multiple points sequentially. The measured points are then synthesized into a three dimensional range image. An alternate approach is to reduce or eliminate scanning by using a detector with multiple elements to capture several distance measurements simultaneously.

When using light pulses to create images, the emitted pulse may intercept multiple objects, at different distances, as the pulse traverses a 3D volume of space. The echoed laser-pulse waveform contains a temporal and amplitude imprint of the scene. By sampling the light echoes, a record of the interactions of the emitted pulse is extracted with the intercepted objects of the scene, allowing an accurate multi-dimensional image to be created. To simplify signal processing and reduce data storage, laser ranging and imaging can be dedicated to discrete-return systems, which record only the time of flight (TOF) of the first, or a few, individual target returns to obtain angle-angle-range images. In a discrete-return system, each recorded return corresponds, in principle, to an individual laser reflection (i.e., an echo from one particular reflecting surface, for example, a tree, pole or building). By recording just a few individual ranges, discrete-return systems simplify signal processing and reduce data storage, but they do so at the expense of lost target and scene reflectivity data. Because laser-pulse energy has significant associated costs and drives system size and weight, recording the TOF and pulse amplitude of more than one laser pulse return per transmitted pulse, to obtain angle-angle-range-intensity images, increases the amount of captured information per unit of pulse energy. All other things equal, capturing the full pulse return waveform offers significant advantages, such that the maximum data is extracted from the investment in average laser power. In full-waveform systems, each backscattered laser pulse received by the system is digitized at a high sampling rate (e.g., 500 MHz to 1.5 GHZ). This process generates digitized waveforms (amplitude versus time) that may be processed to achieve higher-fidelity 3D images.

Of the various laser ranging instruments available, those with single-element photoreceivers generally obtain range data along a single range vector, at a fixed pointing angle. This type of instrument—which is, for example, commonly used by golfers and hunters-either obtains the range (R) to one or more targets along a single pointing angle or obtains the range and reflected pulse intensity (I) of one or more objects along a single pointing angle, resulting in the collection of pulse range-intensity data, (R,I)ᵢ, where i indicates the number of pulse returns captured for each outgoing laser pulse.

More generally, laser ranging instruments can collect ranging data over a portion of the solid angle of a sphere, defined by two angular coordinates (e.g., azimuth and elevation), which can be calibrated to three-dimensional (3D) rectilinear cartesian coordinate grids; these systems are generally referred to as 3D lidar and ladar instruments. The terms “lidar” and “ladar” are often used synonymously and, for the purposes of this discussion, the terms “3D lidar,” “scanned lidar,” or “lidar” are used to refer to these systems without loss of generality. 3D lidar instruments obtain three-dimensional (e.g., angle, angle, range) data sets. Conceptually, this would be equivalent to using a rangefinder and scanning it across a scene, capturing the range of objects in the scene to create a multi-dimensional image. When only the range is captured from the return laser pulses, these instruments obtain a 3D data set (e.g., angle, angle, range) n, where the index n is used to reflect that a series of range-resolved laser pulse returns can be collected, not just the first reflection.

Some 3D lidar instruments are also capable of collecting the intensity of the reflected pulse returns generated by the objects located at the resolved (angle, angle, range) objects in the scene. When both the range and intensity are recorded, a multi-dimensional data set [e.g., angle, angle, (range-intensity)ₙ] is obtained. This is analogous to a video camera in which, for each instantaneous field of view (FOV), each effective camera pixel captures both the color and intensity of the scene observed through the lens. However, 3D lidar systems, instead capture the range to the object and the reflected pulse intensity.

Lidar systems can include different types of lasers, including those operating at different wavelengths, including those that are not visible (e.g., those operating at a wavelength of 840 nm or 905 nm), and in the near-infrared (e.g., those operating at a wavelength of 1064 nm or 1550 nm), and the thermal infrared including those operating at wavelengths known as the “eyesafe” spectral region (i.e., generally those operating at a wavelength beyond 1300-nm, which is blocked by the cornea), where ocular damage is less likely to occur. Lidar transmitters are generally invisible to the human eye. However, when the wavelength of the laser is close to the range of sensitivity of the human eye—roughly 350 nm to 730 nm—the light may pass through the cornea and be focused onto the retina, such that the energy of the laser pulse and/or the average power of the laser must be lowered to prevent ocular damage. Thus, a laser operating at, for example, 1550 nm, can—without causing ocular damage—generally have 200 times to 1 million times more laser pulse energy than a laser operating at 840 nm or 905 nm.

One challenge for a lidar system is detecting poorly reflective objects at long distance, which requires transmitting a laser pulse with enough energy that the return signal—reflected from the distant target—is of sufficient magnitude to be detected. To determine the minimum required laser transmission power, several factors must be considered. For instance, the magnitude of the pulse returns scattering from the diffuse objects in a scene is proportional to their range and the intensity of the return pulses generally scales with distance according to 1/R\hat{ }4 for small objects and 1/R\hat{ }2 for larger objects; yet, for highly-specularly reflecting objects (i.e., those reflective objects that are not diffusively-scattering objects), the collimated laser beams can be directly reflected back, largely unattenuated. This means that—if the laser pulse is transmitted, then reflected from a target 1 meter away—it is possible that the full energy (J) from the laser pulse will be reflected into the photoreceiver; but—if the laser pulse is transmitted, then reflected from a target 333 meters away—it is possible that the return will have a pulse with energy approximately 10\hat{ }12 weaker than the transmitted energy. To provide an indication of the magnitude of this scale, the 12 orders of magnitude (10\hat{ }12) is roughly the equivalent of: the number of inches from the earth to the sun, 10× the number of seconds that have elapsed since Cleopatra was born, or the ratio of the luminous output from a phosphorescent watch dial, one hour in the dark, to the luminous output of the solar disk at noon.

In many cases of lidar systems highly-sensitive photoreceivers are used to increase the system sensitivity to reduce the amount of laser pulse energy that is needed to reach poorly reflective targets at the longest distances required, and to maintain eyesafe operation. Some variants of these detectors include those that incorporate photodiodes, and/or offer gain, such as avalanche photodiodes (APDs) or single-photon avalanche detectors (SPADs). These variants can be configured as single-element detectors,-segmented-detectors, linear detector arrays, or area detector arrays. Using highly sensitive detectors such as APDs or SPADs reduces the amount of laser pulse energy required for long-distance ranging to poorly reflective targets. The technological challenge of these photodetectors is that they must also be able to accommodate the incredibly large dynamic range of signal amplitudes.

As dictated by the properties of the optics, the focus of a laser return changes as a function of range; as a result, near objects are often out of focus. Furthermore, also as dictated by the properties of the optics, the location and size of the “blur”—i.e., the spatial extent of the optical signal-changes as a function of range, much like in a standard camera. These challenges are commonly addressed by using large detectors, segmented detectors, or multi-element detectors to capture all of the light or just a portion of the light over the full-distance range of objects. It is generally advisable to design the optics such that reflections from close objects are blurred, so that a portion of the optical energy does not reach the detector or is spread between multiple detectors. This design strategy reduces the dynamic range requirements of the detector and prevents the detector from damage.

Acquisition of the lidar imagery can include, for example, a 3D lidar system embedded in the front of car, where the 3D lidar system, includes a laser transmitter with any necessary optics, a single-element photoreceiver with any necessary dedicated or shared optics, and an optical scanner used to scan (“paint”) the laser over the scene. Generating a full-frame 3D lidar range image—where the field of view is 20 degrees by 60 degrees and the angular resolution is 0.1 degrees (10 samples per degree)—requires emitting 120,000 pulses [(20*10*60*10)=120,000)]. When update rates of 30 frames per second are required, such as is required for automotive lidar, roughly 3.6 million pulses per second must be generated and their returns captured.

There are many ways to combine and configure the elements of the lidar system-including considerations for the laser pulse energy, beam divergence, detector array size and array format (single element, linear, 2D array), and scanner to obtain a 3D image. If higher power lasers are deployed, pixelated detector arrays can be used, in which case the divergence of the laser would be mapped to a wider field of view relative to that of the detector array, and the laser pulse energy would need to be increased to match the proportionally larger field of view. For example—compared to the 3D lidar above—to obtain same-resolution 3D lidar images 30 times per second, a 120,000-element detector array (e.g., 200×600 elements) could be used with a laser that has pulse energy that is 120,000 times greater. The advantage of this “flash lidar” system is that it does not require an optical scanner; the disadvantages are that the larger laser results in a larger, heavier system that consumes more power, and that it is possible that the required higher pulse energy of the laser will be capable of causing ocular damage. The maximum average laser power and maximum pulse energy are limited by the requirement for the system to be eyesafe.

As noted above, while many lidar system operate by recording only the laser time of flight and using that data to obtain the distance to the first target return (closest) target, some lidar systems are capable of capturing both the range and intensity of one or multiple target returns created from each laser pulse. For example, for a lidar system that is capable of recording multiple laser pulse returns, the system can detect and record the range and intensity of multiple returns from a single transmitted pulse. In such a multi-pulse lidar system, the range and intensity of a return pulse from a closer-by object can be recorded, as well as the range and intensity of later reflection(s) of that pulse-one(s) that moved past the closer-by object and later reflected off of more-distant object(s). Similarly, if glint from the sun reflecting from dust in the air or another laser pulse is detected and mistakenly recorded, a multi-pulse lidar system allows for the return from the actual targets in the field of view to still be obtained.

The amplitude of the pulse return is primarily dependent on the specular and diffuse reflectivity of the target, the size of the target, and the orientation of the target. Laser returns from close, highly-reflective objects, are many orders of magnitude greater in intensity than the intensity of returns from distant targets. Many lidar systems require highly sensitive photodetectors, for example APDs, which along with their CMOS amplification circuits may be damaged by very intense laser pulse returns.

For example, if an automobile equipped with a front-end lidar system were to pull up behind another car at a stoplight, the reflection off of the license plate may be significant-perhaps 10\hat{ }12 higher than the pulse returns from targets at the distance limits of the lidar system. When a bright laser pulse is incident on the photoreceiver, the large current flow through the photodetector can damage the detector, or the large currents from the photodetector can cause the voltage to exceed the rated limits of the CMOS electronic amplification circuits, causing damage. For this reason, it is generally advisable to design the optics such that the reflections from close objects are blurred, so that a portion of the optical energy does not reach the detector or is spread between multiple detectors.

However, capturing the intensity of pulses over a larger dynamic range associated with laser ranging may be challenging because the signals are too large to capture directly. One can infer the intensity by using a recording of a bit-modulated output obtained using serial-bit encoding obtained from one or more voltage threshold levels. This technique is often referred to as time-over-threshold (TOT) recording or, when multiple-thresholds are used, multiple time-over-threshold (MTOT) recording.

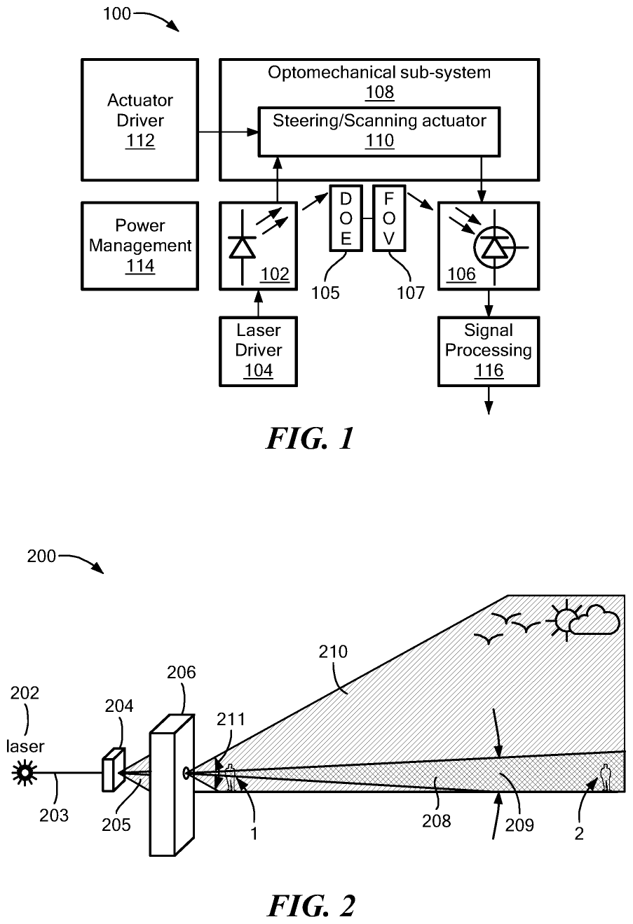

FIG. 1 shows an example scanned lidar system 100 having signal processing with spatio-temporal thresholding in accordance with the present disclosure. The system 100 includes an illumination source 102, shown as laser diode, connected to laser driver 104, and an illumination optic or optics 105. The illumination source (laser) 102 produces an output (or, laser output). An optic 105 receives the laser output and produces a fan-beam output having a desired irradiance distribution with multiple parts or regions, as described in further detail below. In example embodiments, the optic 105 can include, but is not limited to, a diffractive optical element (DOE), a gradient-index (GRIN) lens, and/or a compound lens system or assembly (which can include one or more mirrors or reflective surfaces in addition to lenses or refractive optical elements). In cross section, the fan-beam can have a generally oval or elliptical shape, e.g., of any desired eccentricity (including an eccentricity value of one). Appropriate pumping energy may be supplied by suitable sources, e.g., diodes lasers, for the case where laser 102 includes a non-semiconductor active medium such as a crystalline or glass material (host or matrix) doped with a rare earth element or elements. An optical receiver or detector 106, shown as a representative photodiode. The detector 106 can be or include an array of induvial detectors, e.g., a one-dimensional array (1×N) or a two-dimensional array (M×N). A field of view (FOV) 107 of the detector is shown on the optical path between the laser (illumination source) 102 and the detector 106, which is directed to and “viewing” the FOV 107. Detector 106 operates to detect energy reflected from objects and/or surfaces in the FOV 107. An optomechanical subsystem 108, which typically includes an actuator for transmit beam steering 110, can be included to scan the illumination source 102 and receiver 106. An actuator driver 112 can control the movement of the actuator 110. Additional optics (not shown) can be used for either or both of the illumination side (with illumination source 102) and receive side (with receiver/detector 106) of system 100.

The system 100 further includes a power management block 114, which provides and controls power to the system 100. Once received at the receiver 106, the incident photons are converted by the receiver (e.g., photodiodes) to electrical signals, which can be read-out by for signal processing, including amplification, discrimination, timing, digitization, and point cloud generation, as indicated by signal processing block 116. As described more fully below, the read-out data can be processed with spatio-temporal filtering to reduce false detections.

FIG. 2 is a diagram of an exemplary system 200 having spatio-temporal filtering and utilizing a lidar illumination optic including a laser 202 operative to produce a laser output 203, and an illumination optic 204, that is configured to receive the laser output 203 and to produce a fan-beam output 205 having a desired irradiance (or, radiant flux) distribution over sections through the beam 205 taken normal to the beam's axis of propagation. In example embodiments, the illumination optic 204 can be or include a diffractive optical element (DOE), a gradient-index (GRIN) lens, and/or a compound lens system or assembly, or the like. As shown, the fan-beam output 205 can include a first beam region 208 having an angular spread 209 in a first direction (e.g., vertical, or substantially vertical) and a second beam region 210 having an angular spread 211 in the first direction. In alternate embodiments, fan-beam output 209 can include more than two component beam regions.

The two component beam regions of fan-beam output 205 can be used or considered as a “far look” beam region 208 and “near look” beam region 210. The average irradiance within the first beam region 208 is higher than that of the second beam region 210, in exemplary embodiments. Such an irradiance distribution, with first beam region 208 configured for relatively longer (“far look”) distances, is indicated by its darker shading compared to that of second beam region 210. Fan-beam output 205 provides some irradiance distribution for illuminating and viewing objects closer to the system 200 while also providing a higher irradiance distribution for illuminating and viewing objects further away from the system 200. While the transition between the two beam regions 208, 210 is shown as abrupt, this is merely for ease of explanation, and the distribution may be gradual or graded, in some embodiments. A person is indicated at representative near and far locations 1, 2, respectively.

As shown, system 200 also includes a scanning system 206 for scanning the output the fan beam output in a desired direction, e.g., azimuth. Photodetectors (not shown) can be used to detect the returns from the distant objects/surfaces and a timing system (not shown) can be used to calculate distances (ranges) accordingly, forming a 3D landscape corresponding to the objects and surfaces in the FOV and the related field-of-regard (FOR) (the volume subtended by the scanned FOV).

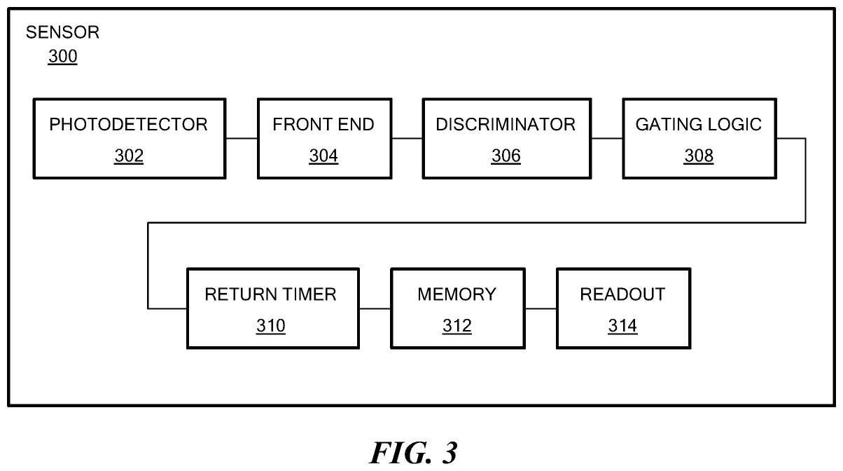

FIG. 3 shows an example lidar time-of-flight sensor 300 having photodetectors in accordance with example embodiments of the disclosure. The sensor 300 can include a photodiode 302 array to detect photons reflected from a target illuminated with transmitted energy. A front-end circuit 304, which may include an amplifier for example, receives a current pulse generated by an optical pulse on the photodiode 302 and converts the current signal into an output, for example, an output voltage pulse. A discriminator circuit 306, such as a voltage discriminator, can determine if the current pulse, or its representation after signal conversion by the front-end circuit, is above one or more thresholds. Gating logic 308 receives an output from the discriminator 306 to match received signals with transmitted signals, for example. A return timer circuit 310, which can include a time-to-digital converter (TDC) for generating time-stamps, can determine the time from signal transmission to signal return so that a distance from the sensor to the target can be determined based on so-called time of flight. A memory 312 can store signal information, such as time of flight, time over threshold, and the like. A readout circuit 314 enables information to be read from the sensor.

A data processing and calibration circuit 313 may be inserted between the memories 312 and the readout 314 which may perform any number of data correction or mapping functions. For example, the circuit may compare timing return information to timing reference information and convert timing return information into specific range information. Additionally, the circuit may correct for static or dynamic errors using calibration and correction algorithms. Other possible functions include noise reduction based on multi-return data or spatial correlation or objection detection. A possible mapping function may be to reshape the data into point-cloud data or to include additional probability data of correct measurement values based on additionally collected information from the sensor.

In example embodiments of the disclosure, lidar images are filtered to reduce false alarms after data capture. Conventional false alarm reduction (FAR) techniques, such as amplitude thresholding, only consider the signal characteristics of each measurement on its own, out of the context of the other measurements that make up an image. For example, amplitude thresholding is a simple determination of whether the amplitude of one measured signal is larger or smaller than the set threshold.

Example embodiments of the disclosure include a lidar system having spatio-temporal thresholding that uses spatial information for a whole image, thereby giving each measurement context by examining spatially adjacent measurements. In some embodiments, a lidar system may also use temporal information by retaining a history of past images. The spatial and temporal information may be combined to generate a probability that any given measurement in an image is actual signal return. The image can then be thresholded to remove measurements that do not meet a given probability criteria.

In the example embodiment elaborated on below, the language used refers to processing data in a lidar image made up of a dense data set of “pixels”, each pixel corresponding to an individual lidar measurement with a range value. This language is a conceptual convenience and should not be understood to limit the claim to exclude operation on point cloud data, sparse data sets or any other means of storing or referring to collections of multiple lidar measurements. The general method of spatio-temporal filtering disclosed herein is applicable to any lidar data set in which the spatial coordinates of the returns are stored or calculable, in cartesian, polar or any other coordinate system.

In example embodiments, processing is performed on the basis that a return is more likely to be real if it is spatially adjacent to other returns. Spatial adjacency refers to the measure of how many returns are nearby within a defined three-dimensional area around the return of interest. More nearby returns mean greater spatial adjacency.

Objects of interest to operators of a lidar system that are within a detectable distance will often generate multiple spatially adjacent returns. While there may be some objects of interest that generate only a single spatially isolated return, in general greater spatial adjacency means a higher probability of being real.

One can also consider that false alarms from a lidar detector are essentially random in frequency. There is a relatively low probability of multiple spatially adjacent returns having false alarms at the same range. Thus, if there are multiple adjacent returns at the same range it is more likely that they are reflections from a real object.

Because spatial adjacency has a positive correlation to the probability that a return is real, it can be used as a thresholding criteria so that returns with a spatial adjacency below the threshold are not displayed.

In addition, a return is more likely to be real if there is a history of spatially adjacent returns. Consider a simple example of a static scene where there is no apparent motion between sequential images of the scene. Since photodetector noise is essentially random, there is a low probability of false alarms being registered on a given pixel at the same range across sequential images. For a static scene, this characteristic can be used to reject false alarms by histogramming the returns for each pixel across multiple sequential images. This means that for each pixel index (X,Y dimension), the range space (Z dimension) would be divided up into bins, such as a bin for 0-1m, 1-2 m, 3-4 m etc. When a return is detected on a pixel, the count for the bin that corresponds to the range of the return is incremented for that pixel.

Because false alarms are random, over a large enough time period they would be spread evenly across all of the range bins. Conversely, real returns would stack up in range bins because the object generating the return is persistent. Returns can then be thresholded by the number of counts for the associated range bin to remove false alarms. Returns on pixels that don't meet the thresholding criteria will be removed from the displayed image.

In real world lidar systems, objects being measured tend to move relative to the observer. Either the observer is stationary and the objects (cars, bicycles, people, animals etc.) move, or the lidar system is mounted on a vehicle and it moves relative to the scene. Because of this motion, returns originating from a real object can show up on different pixels of the lidar image over time as the object moves across the imaged scene. However, using the simple range histogram multi-pulse processing above may result in the returns from the moving object being rejected as false alarms, because they are not being registered on the same pixel each measurement. Example embodiments of the disclosure improve upon this performance by being less likely to reject returns from moving objects or objects that provide faint signal return.

In example embodiments of the disclosure, a lidar system processes image data using spatiality and time—i.e., were there other returns in the past that were spatially adjacent to this return. This improves filtering performance.

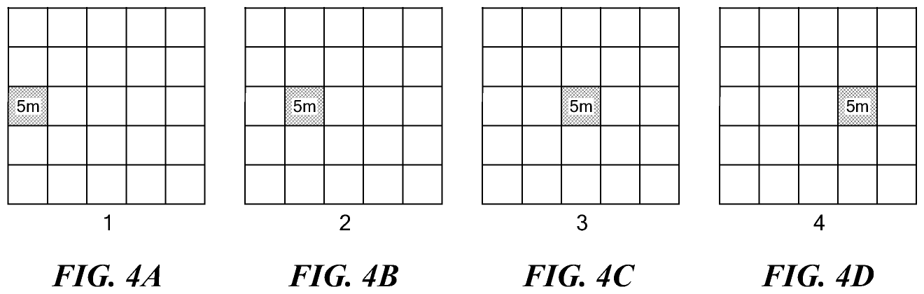

FIGS. 4A-4D show a time sequence of an example 5×5 pixel lidar image as an object moves through an imaged scene. The object position in the image is indicated by the label “5 m”, which represents a range of 5 meters for the object. The object is shown in each of the FIGS. 4A-4D in a different location in the image due to movement of the object and/or the lidar system. The spatial coordinates of the object can be defined by X,Y (column, row) indices in the image and Z (distance).

As can be seen, the detected object is at the same range in each image and shows up on different pixels over time. In the illustrated sequence, the return exhibits a low degree of spatial adjacency (no other nearby returns).

In example embodiments, the system maintains persistent memory for each pixel in the image which contains a calculated probability that a return for that pixel at that range is real.

When each new image is captured, for each pixel in the image, a search is conducted of adjacent pixels in the X and Y dimensions for other pixels with returns. If a return is found in the search area, then the probability value for the corresponding range bin of the center pixel is increased. Other probability values for other range bins may be decreased. Then, for each return in the image, if the probability for the corresponding range bin exceeds the programmed threshold, the return is displayed.

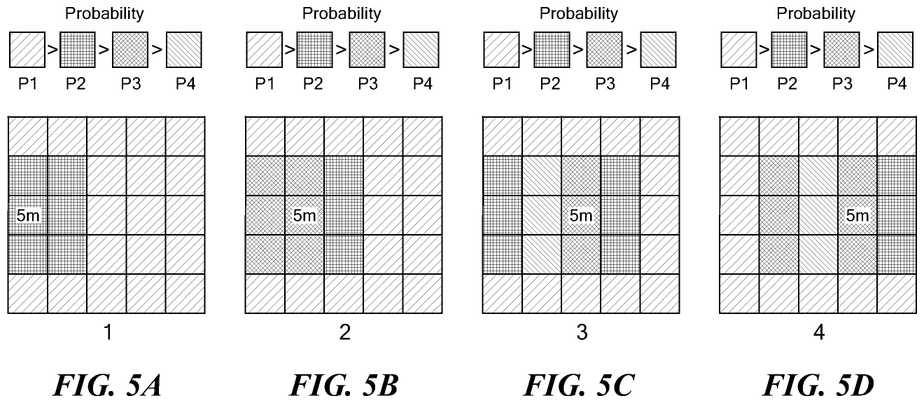

FIGS. 5A-5D show examples of the processing described above for the object movement shown in FIGS. 4A-4D. In the illustrated embodiment, a square search area around each pixel is used, with a 1-pixel adjacency in the X and Y dimensions for a 3×3 total search area. The relative probabilities for each pixel's 5 m range bin are indicated in the figure in order. As the 5 m return for the object moves through the scene, pixels ahead of the direction of travel start to increase in probability before the return makes it onto that pixel. By the time the return makes it to the new pixel, the new pixel has registered the history of a return at that range in the region for multiple iterations, and the probability value has increased significantly above the baseline. In example embodiments, if the image were thresholded by probability P3 or higher, the return remains in the displayed image. Conversely, a false alarm showing up as a return in only one image would generate a small probability increase and would be rejected by thresholding. The exception would be false alarms adjacent to a real return. Because of the “aura” of probability surrounding the real return, the false alarm would be likely to be displayed as well.

It understood that various parameters can be adjusted to meet the needs of a particular application. For example, search area can be increased or decreased in the X and Y dimensions (X/Y adjacency) independently. Different applications may benefit from different search area sizes and shapes. In addition, aggregating probability from adjacent range bins (Z adjacency) can increase performance, and the Z adjacency can be changed depending on the application. This is desirable because a persistent return from a real object may be straddling the boundary of two range bins, so that the calculated range corresponds to one bin in one image and other bin in the next. Also, bin size can be changed to optimize results, for example to match the range accuracy of the system. Further, the amount by which probability for a bin is increased and decreased can be adjusted independently for different effects.

In example embodiments, processing is performed in a series of stages after image acquisition. The probability for each range bin of each pixel in the image is decreased by a set amount. In the absence of new stimulus, the probability values naturally decay over time back to the baseline. For each pixel in the image, a search is conducted in a defined area around the active pixel. For any returns found in the search pixels, the probability stored in the range bin of the active pixel which corresponds to the range of the search pixel return is increased by the probability decrease amount from step 1 plus a defined increase amount. These increase and decrease amounts can be specified separately. Adding back the probability decrease amount is desirable because otherwise the probability values may never grow unless the increase amount is greater than the decrease amount. Depending on the application, it might be useful to have a bias towards greater probability decay by keeping the increase amount smaller than the decrease amount. Further, for each pixel in the image, if the pixel has an associated return, if the probability for the range bin corresponding to the return range is greater than or equal to the defined probability threshold, display that return in the final image. Otherwise, do not display the return. As discussed previously, when calculating probability for this step, it is desirable to include probabilities from adjacent range bins to account for aliasing due to normal range inaccuracy from image to image.

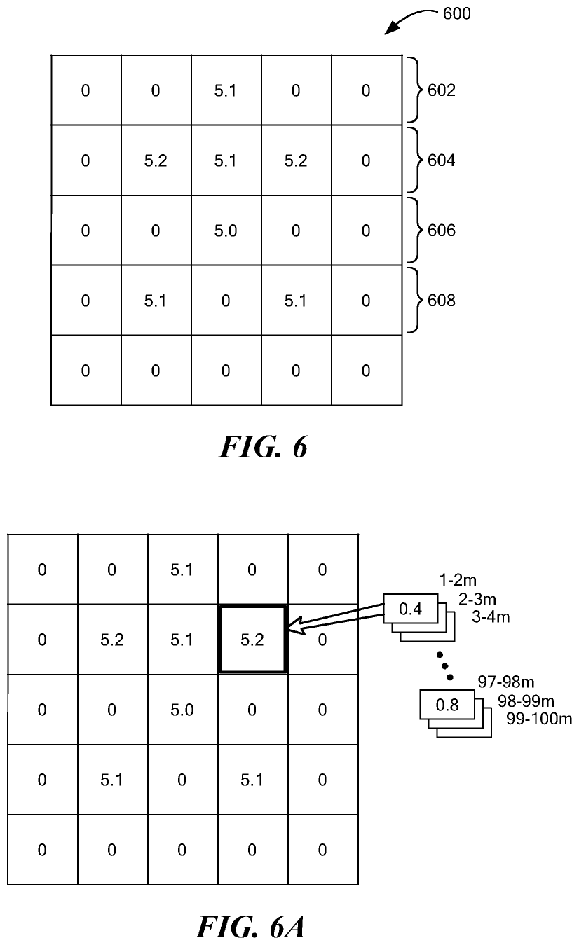

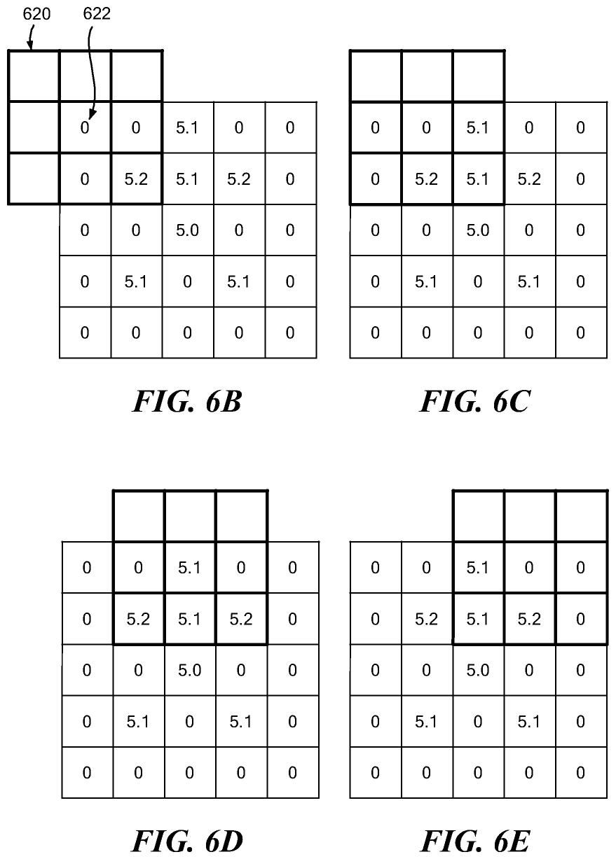

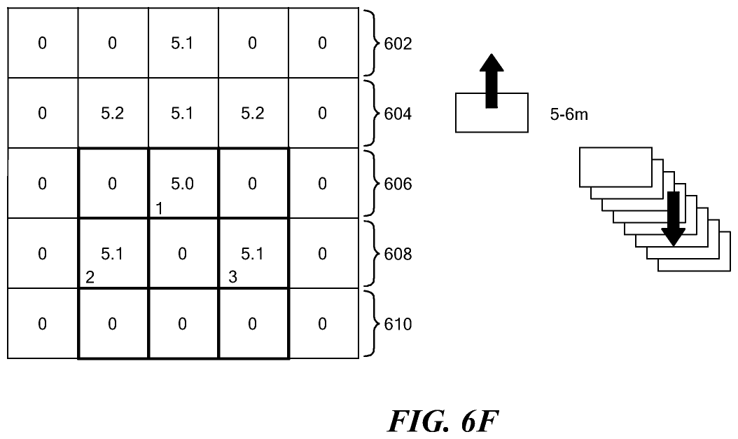

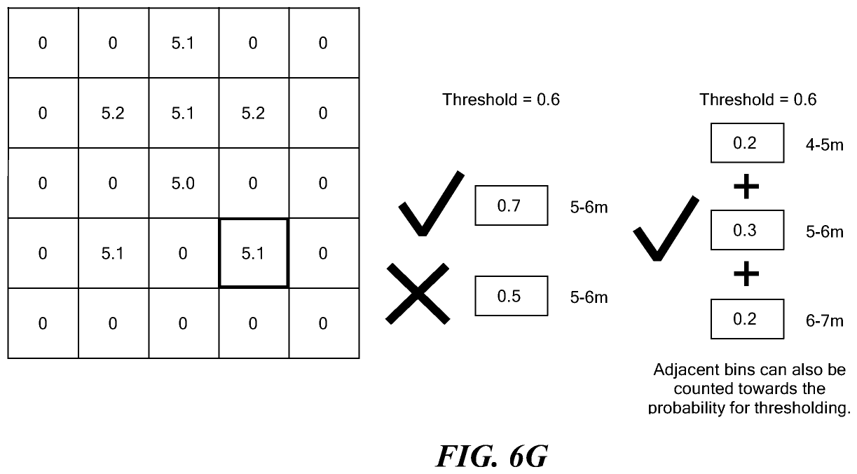

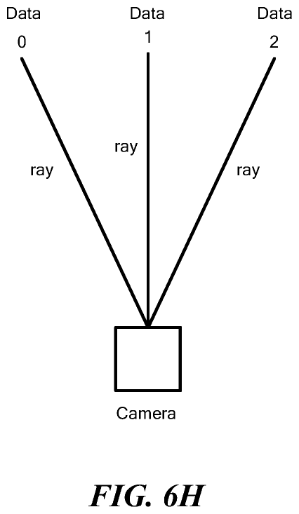

FIG. 6 shows an example 5×5 lidar image 600 having 25 range measurements. As can be seen, in the central region of the image there are returns with range values 5.1 in the first row 602, 5.2, 5.1, and 5.2 in the second row 604, 5.0 in the third row 606, and 5.1 and 5.1 in the fourth row 608, generally corresponding to an object in the shape of a person at about five meters distance. Range measurements of 0 indicate lack of signal return.

FIG. 6A shows an example probability field for the data in FIG. 6. In the illustrated embodiment, probability is binned by range for each measurement in the image. Bin width (distance covered by each bin) and number of bins can be selected to meet the needs of a particular application. In the illustrated embodiment, each bin has a width covering one meter of range. In the illustrated embodiment, range bins for 1-2 m, 2-3 m, and 3-4 meters have an example probability of real return of 0.4 and range bins for 97-98 m, 98-99 m, and 99-100 meters have an example probability of real return of 0.8

It is understood that any practical probability scheme can be used to meet the needs of a particular application. For example, probabilities can increase and/or decrease linearly, exponentially, stepped, and the like. In addition, probability increases can be different from probability decreases.

FIG. 6B shows the image data of FIG. 6A with a 3×3 search window 620 for spatial adjacency. The search window is centered on the pixel with X, Y coordinates 0,0. The pixel at the center of the search window is the pixel which the algorithm is currently calculating probability for. The search window moves as the data is processed as shown in FIGS. 6C-6E. The search window moves across the image to process each pixel in the image.

Referring now to FIG. 6F, the center of the search window is the pixel with X, Y coordinates of 2,3. There are 3 other returns in the search window around the center pixel, each with ranges that fall between 5 and 6 meters. As a result, the probability for the 5-6 m range bin of the center pixel increases. The probability of the other range bins for the center pixel will decrease, which is indicated by the down arrow, since no signal return was found at other ranges in the search window to offset the global probability decay. The probability increases may be constant, e.g., any number of returns=+1 probability, proportional to the number of returns found, e.g., 3 returns=+3 probability, or any other suitable increase scheme. Probability can be tracked as an integer or floating point value.

FIG. 6G shows the image data with example thresholds. After calculating probabilities for the returns, the returns can be thresholded. For each non-zero range return, if the probability in the corresponding range bin is greater than the threshold, the return is kept, and deleted if not. For example, if a probability for a return is 0.7, the return, shown as range 5.1 m, is kept since the 0.6 threshold is exceeded. If the probability is 0.5 for the return, then the return is deleted since it is below the threshold of 0.6. In some embodiments, such as that shown on the right side of the figure, adjacent range bin probabilities can be summed. As shown, a 0.7 probability can compute as a sum of a 0.2 probability at the 4-5 m range bin, a 0.3 probability at the 5-6 m range bin, and a 0.2 probability at the 6-7 m range bin. The summed range bin probabilities exceed a 0.6 threshold.

FIG. 6H shows example lidar data for a scan for an array having values that can defined as {index0, index1, index2}={data0, data1, data2}. Adjacency can be defined in terms of data indices so that any return on the ray of measurement 1 is considered adjacent to another return on the ray of measurement 2, regardless of the range. However, two returns at short range on adjacent measurements defined this way are actually much closer to each other than two returns at longer ranges, since the rays diverge. In another embodiment, adjacency is determined by first calculating the cartesian coordinates of each return and then determining adjacency based on that calculation. The different adjacency determinations have different search volume shapes for determining adjacency. It is understood that defining adjacency as neighboring measurements results in a search area that is variable with range, whereas defining adjacency based on cartesian coordinates results in a search area that is constant with range.

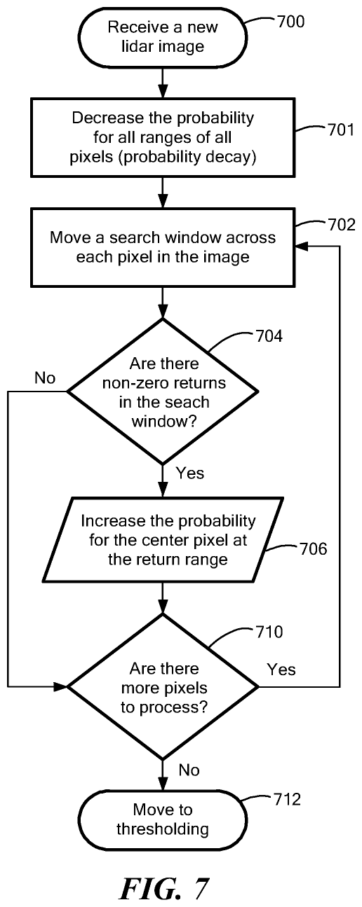

FIG. 7 shows an example sequence of steps for processing image data. In step 700, data for a new image is received. In step 701, all probabilities for all pixels and ranges are decreased (probability decay). In step 702, a search is performed in a bounded window around each pixel in the image. In step 704, it is determined if there are non-zero returns in the search area. If there are non-zero returns in the search area, in step 706, the probability for the center pixel of the search window at that range is increased. Processing continues from an increase or decrease in probability in step 710, where it is determined whether there are more measurements to process. If not, thresholding is initiated in step 712.

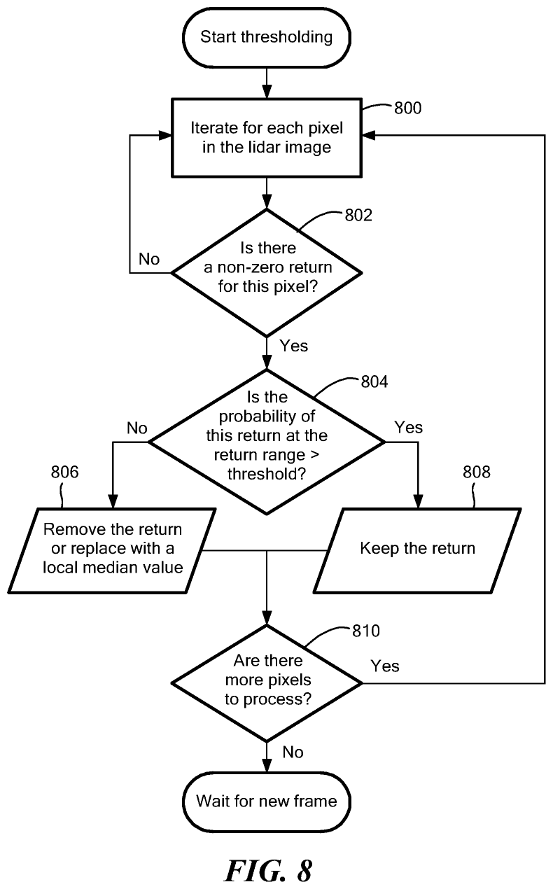

FIG. 8 shows an example sequence of steps for thresholding data. In step 800, processing iterates for each lidar measurement in the image. In step 802, it is determined whether there is a non-zero return for this measurement. If not, processing continues in step 800. If so, in step 804, it is determined whether the probability of the current measurement at the return range is greater than a threshold. If not, in step 806, the return is removed, or replaced with another value, for example a local median. If so, in step 808, the return is kept. Processing then continues in step 810 where it is determined whether there are more measurements to process. If so, processing continues in step 800. In not, the process waits for a new image.

Example embodiments of the disclosure provide a spatial adjacency filter, which uses information about the number of close spatial neighbors of a lidar return as criteria for thresholding, which refers to a decision on whether to keep or delete lidar returns from an image. Example embodiments of a spatio-temporal filter uses both the current and historical spatial adjacency of returns to calculate a probability that a given lidar return is a real return and not a spurious noise event.

In general, a lidar image refers to a set of lidar measurements covering all or part of a scene of interest. Each measurement may or may not have resulted in a return, a non-zero range. A return could be the result of either a reflection from a real object, or a noise event. Range refers to a range to target, i.e., the measured distance from target to lidar system. In embodiments, spatial adjacency is calculated by doing a search of a bounded N-dimensional area around each return. For a dense image data format, where there is an entry for every measurement regardless of whether there was a return, example processing can include moving an image processing kernel across a 2D array of stored image data and checking each adjacent array index for a non-zero return. If the image data format is not dense, containing only entries for non-zero returns, then additional computation can be done to determine which other returns are spatial neighbors.

If a return for a measurement has other spatially adjacent returns around it, that increases the probability that the return for that measurement is real. Probability can be calculated as an absolute, e.g., if a return has two or more other adjacent returns, then it is real. It can also be calculated proportionally, so that each return in the search window adds a pre-determined amount to the probability figure. In embodiments, the history of returns in past images can be used in the form of a 3-dimensional probability array. For each measurement X, Y index pair, the algorithm maintains a table of probabilities in the Z dimension for different ranges.

For example, where a dense image data format is assumed, each lidar measurement has a data entry regardless of whether a return was detected. The adjacent array indices in the dense image data are guaranteed to be spatially adjacent in two dimensions (X and Y), and to correspond to unique spatial locations. For each X,Y index pair in the image data, a table of probabilities for each range (Z dimension) is maintained. For computational reasons, it is most efficient to maintain range “bins”, where each bin covers a span of the maximum range.

In example implementations, if a return for a measurement has other spatially adjacent returns, the probability value in the range bin for that measurement corresponding to the range of the adjacent return is increased. All the probability values in other range bins that do not correspond to an adjacent return are decreased. In this way, probability is tracked as a function of range. Probability increases over time for ranges where there are persistent returns over multiple images and decreases in the absence of returns. The decrease in probability over time in the absence of adjacent returns makes the algorithm analogous to a weighted averaging function, but without having to process all the data from multiple images at once.

It is understood that any suitable technique can be used for implementing a history of spatial adjacency for calculating probability, such as storing whole images in memory for use in calculations, storing counts of spatial adjacency for each spatial location for previous images, storing the result of other intermediate calculations using data from previous images, and/or probability vs. range represented by a continuous function whose terms are modified every iteration instead of discrete values in range bins.

In example embodiments, thresholding iterates over all returns in the image data. For each return, the probability value that corresponds to the return's range is compared to the threshold value for the filter. If the probability is greater than the threshold, the return stays in the output data set. If the probability is less than the threshold, the return is removed from the output data set. Optionally, instead of simple removal, returns whose probability is lower than the threshold can be replaced by another calculated value, such as a local median.

If range bins are used to store probability, multiple adjacent range bins can be added together to calculate probability, to account for situations where spatially adjacent returns fall in different bins. For example, two returns at 4.9 m and 5.1 m could end up in different bins despite being very close to each other spatially. If a continuous function is used to represent probability, then the function should be integrated around the range of the return.

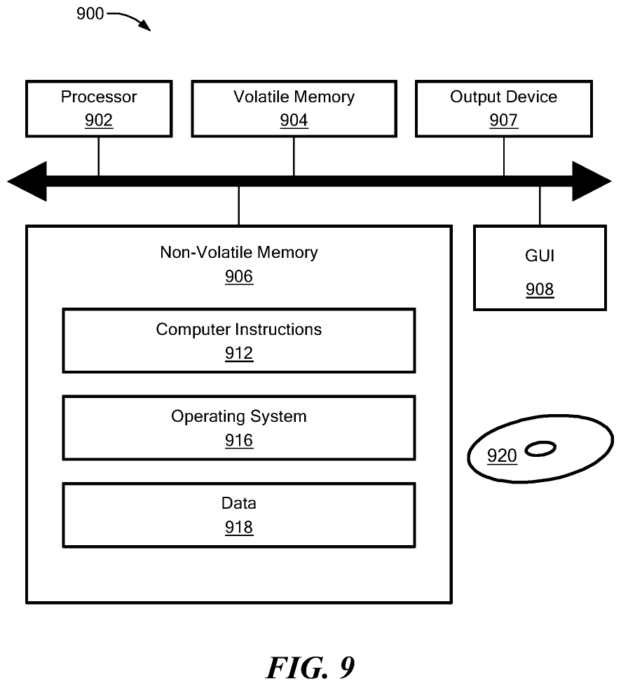

FIG. 9 shows an exemplary computer 900 that can perform at least part of the processing described herein. For example, the computer 900 can perform processing for spatio-temporal thresholding, as described above. It is understood that processing steps In FIG. 7 and FIG. 8, for example, can be performed in any practical order unless an order is explicitly stated or required to performing the processing. The computer 900 includes a processor 902, a volatile memory 904, a non-volatile memory 906 (e.g., hard disk), an output device 907 and a graphical user interface (GUI) 908 (e.g., a mouse, a keyboard, a display, for example). The non-volatile memory 906 stores computer instructions 912, an operating system 916 and data 918. In one example, the computer instructions 912 are executed by the processor 902 out of volatile memory 904. In one embodiment, an article 920 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable embedded processors executing one or more computer programs to perform the functions of the system. All or part of the system may be implemented as special purpose logic circuitry (e.g., an FPGA (field programmable gate array) and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method, comprising:
(a) receiving a first set of lidar data comprising multiple measurements having non-zero range returns;
(b) processing each measurement in the first set of lidar data to identify other spatially adjacent measurements with non-zero returns using a defined search area around the measurement currently being processed;
(c) for each spatially adjacent measurement with a non-zero return in the search area surrounding the measurement currently being processed, increasing a metric of a probability for the measurement currently being processed of a real return at a range of the adjacent non-zero return;
(d) persistently storing the metrics of probability in memory across iterations of processing each measurement in the first set of lidar data;
(e) decreasing the probability metric for ranges of measurements for which spatially adjacent returns were not found within the search area;
(f) receiving subsequent sets of lidar data at a time after receiving the first set of lidar data;
(g) processing the subsequent sets of lidar data in accordance with steps (a)-(e) to identify spatially adjacent returns and update the persistent probability metrics for each measurement at each range;
(h) for each of the first and subsequent sets of lidar data, after updating the probability for each measurement having a non-zero return, comparing the probability metric for the measurement at the range of the return to a threshold to identify real returns;
(i) removing returns whose probability does not meet the threshold and/or or replacing them with another value; and
(j) displaying an image based on the identified real returns.

2. The method according to claim 1, wherein the search area and/or spatial adjacency are defined in terms of elevation and azimuth of lidar measurements.

3. The method according to claim 1, further including defining the search area and/or spatial adjacency using calculated cartesian coordinates of a return using elevation, azimuth and range of the measurement that generated the return.

4. The method according to claim 1, wherein the probability of a measurement with a non-zero return at the range of that return is compared to a probability threshold, and further including combining the probabilities of range bins adjacent to the range bin corresponding to the range of the return prior to comparison to the threshold.

5. The method according to claim 1, further including maintaining a table of range bins for each measurement with a unique elevation and azimuth, wherein each the range bins stores a probability metric for a sub-set of possible ranges.

6. The method according to claim 1, wherein pixels comprise photodetectors that generate random noise in the measurements.

7. The method according to claim 6, wherein false alarms are generated by the random noise.

8. A system, comprising:
one or more processors and one or more memories in a lidar system configured to:
(a) receive a first set of lidar data comprising multiple measurements having non-zero range returns;
(b) process each measurement in the first set of lidar data to identify other spatially adjacent measurements with non-zero returns using a defined search area around the measurement currently being processed;
(c) for each spatially adjacent measurement with a non-zero return in the search area surrounding the measurement currently being processed, increase a metric of a probability for the measurement currently being processed of a real return at a range of the adjacent non-zero return;
(d) persistently store the metrics of probability in memory across iterations of processing each measurement in the first set of lidar data;
(e) decrease the probability metric for ranges of measurements for which spatially adjacent returns were not found within the search area;
(f) receive subsequent sets of lidar data at a time after receiving the first set of lidar data;
(g) process the subsequent sets of lidar data in accordance with steps (a)-(e) to identify spatially adjacent returns and update the persistent probability metrics for each measurement at each range;
(h) for each of the first and subsequent sets of lidar data, after updating the probability for each measurement having a non-zero return, compare the probability metric for the measurement at the range of the return to a threshold to identify real returns;
(i) remove returns whose probability does not meet the threshold and/or or replacing them with another value; and
(j) display an image based on the identified real returns.

9. The system according to claim 1, wherein the search area and/or spatial adjacency are defined in terms of elevation and azimuth of lidar measurements.

10. The system according to claim 8, wherein the system is further configured to define the search area and/or spatial adjacency using calculated cartesian coordinates of a return using elevation, azimuth and range of the measurement that generated the return.

11. The system according to claim 8, wherein the probability of a measurement with a non-zero return at the range of that return is compared to a probability threshold, and further including combining the probabilities of range bins adjacent to the range bin corresponding to the range of the return prior to comparison to the threshold.

12. The system according to claim 8, wherein the system is further configured to maintain a table of range bins for each measurement with a unique elevation and azimuth, wherein each the range bins stores a probability metric for a sub-set of possible ranges.

13. The system according to claim 8, wherein pixels comprise photodetectors that generate random noise in the measurements.

14. The system according to claim 13, wherein false alarms are generated by the random noise.
